(19) United States
(12) Patent Application Publication
(10) Pub. No.: US 2025/0165919 A1
(43) Pub. Date: May 22, 2025

(54) DYNAMIC INVENTORY TRACKING AND DISPENSING SYSTEM

(71) Applicant: ItsWare Inc., Palo Alto, CA (US)

(72) Inventors: Armaan Saini, La Palma, CA (US); Casey Spencer, Woodland Hills, CA (US); Brian Bentow, Palo Alto, CA (US)

(21) Appl. No.: 18/935,524

(22) Filed: Nov. 2, 2024

Related U.S. Application Data
(60) Provisional application No. 63/595,715, filed on Nov. 2, 2023.

(51) Int. Cl. G06Q 10/087; G06K 7/10; G07C 9/00

(52) U.S. Cl. CPC G06Q 10/087; G06K 7/10297; G07C 9/00182

(57) ABSTRACT

A dynamic inventory tracking and dispensing system has one or more cabinets, combination near-field communication (NFC) and radio frequency identification (RFID) tags attached to items being tracked, and a database and accompanying software to manage the operation of the cabinet and track items. Each cabinet has a touch screen device, an NFC reader, and an internal RFID scanner. The contents of the cabinet can be displayed on the touch screen. A user identifies himself or herself to the cabinet using a mobile device with the cabinet's NFC reader or an access code, and retrieves items from the cabinet or replaces previously retrieved items. The cabinet then rescans its contents with the internal scanner and automatically updates the database to reflect items checked out or returned, associating checked-out items with the user who took them, or if currently offline, locally stores the update and synchronizes with the database upon reconnection.

### RELATED APPLICATION

This application claims priority to U.S. Provisional Patent Application Ser. No. 63/595,715 for a “Dynamic Inventory Tracking and Dispensing System,” filed Nov. 2, 2023, and currently co-pending, the entirety of which is incorporated herein by reference.

### FIELD OF THE INVENTION

The present invention pertains generally to inventory storage and tracking. More particularly, the present invention provides a container capable of automatically tracking its contents through radio frequency identification and updating a backend system to show the status of its contents.

### BACKGROUND OF THE INVENTION

Companies commonly need to track tools, manuals, or other items frequently used on a temporary basis by workers. Methods for tracking “check-out” and “check-in” of items range from simple pen-and-paper logs to technological solutions using computers and software.

Since check-in and check-out can be tedious and error-prone, some software solutions work with hardware such as scanners to allow for quick and accurate logging of items. The item is placed where the scanner can read a bar code or other tag attached to it for check-out or check-in, much like checking out a book in a modern library. This is a partial improvement, but still requires a specific action by users to check out or check in an item, and thus is error prone. For example, a user may forget to check in an item when returning it, and so it shows as unavailable in the software. Or a user may neglect to go through the check-out process, and an item appears to be in inventory but is not present, with no indication of where to find it.

In view of the above, it would be advantageous to provide a system for tracking inventory that avoids mistaken or intentional neglect of a check-out and check-in process.

### SUMMARY OF THE INVENTION

Disclosed is a dynamic inventory tracking and dispensing system having one or more hardware enclosures or cabinets, radio frequency identification (RFID) or near field communication (NFC) tags attached to items being tracked, and a database and accompanying software to manage the operation of the cabinet and track items.

A preferred embodiment of the hardware enclosure is an 835 mm×600 mm×1935 mm upright enclosure resembling a metal locker. The materials composing the locker's walls are chosen specifically to reject radio frequencies (RF) so as to prevent the locker's internal RFID scanner from picking up RFID tags outside the enclosure. The door is transparent and composed of similarly RF rejecting material. The enclosure sits upon four locking caster wheels to allow for mobility. The enclosure can be optionally outfitted with a security camera for monitoring enclosure interactions by users and, in some embodiments, user authentication purposes via facial recognition. Some embodiments of the enclosure can be optionally outfitted with a fingerprint scanner in its door for user authentication purposes. Preferred embodiments of the enclosure are equipped with an NFC reader in the door for user authentication purposes via an NFC-based mobile pass. In addition to authenticating using a mobile pass, preferred embodiments allow a user to input the user's access code into the touch screen running the cabinet application to authenticate and open the door. Some embodiments also provide other authentication mechanisms, such as password, PIN, or the customer company's employee security badges.

Preferred embodiments of the enclosure are powered by a 110 v power supply. The enclosure scans its contents with an Impinj R2000 RFID scanner on the 860M Hz-960 MHz frequency range, and which is located in the electronics compartment at the top of the cabinet. Embedded in the enclosure door is a 15″ touch screen monitor associated with a computer located with the RFID scanner in the electronics compartment at the top of the cabinet. A preferred embodiment of the computer runs Windows 10 Enterprise IoT, and runs an application designed to operate the cabinet (“the cabinet app”) in kiosk mode. This touch screen serves as the primary interaction interface between the user and the enclosure.

Items the user wishes to track are tagged by the dynamic inventory tracking and dispensing system via RFID tags. In a preferred embodiment, the RFID tags are single or dual frequency tags, such as those manufactured by Avery Dennison and sold under the trade name AD Slim DF. In a preferred embodiment, the tags are dual frequency UHF 860-960 MHz/NFC 13.56 MHz. Dual frequency allows for read compatibility with both the UHF scanner within the inventory enclosure and modern smartphones using NFC. RFID tags are affixed to individual items-one tag per item, via an adhesive backing and are not reusable.

The software suite incorporates a cabinet app, backend application programming interface (API), backend database, mobile device apps for popular mobile operating systems, a responsive web app, Jira app, and Trello app.

The cabinet app is the main point of user interaction with the cabinet and is accessible via the cabinet's embedded touchscreen. The cabinet interface is also responsible for making calls to the backend API, which then updates the backend database with inventory changes after each user interaction, via WiFi or ethernet connection configurable in cabinet setup. However, the cabinet also supports an offline mode in case of disruption of internet connectivity, and syncs with the backend API when the internet connection is restored. At rest, this interface displays a scrollable list of the cabinet's current contents, their quantities, any user specified item qualities (version, color, etc.), and any images associated with each piece of inventory. Should a cabinet administrator so choose, this list can be hidden behind an authentication requirement, in which case the cabinet interface will display the dynamic inventory tracking and dispensing system logo by default, but can be configured by an administrator to show a custom logo.

At rest, the cabinet is locked. When a user is authenticated, the cabinet is unlocked. Opening the door triggers a switch alerting the cabinet interface that the door has been opened and an interaction event is taking place. Closing the door releases the switch, and initiates an automatic re-tabulation of the enclosure contents via UHF RFID scan. Whatever is now missing or has been added relative to the cabinet's prior contents is attributed to the user that initiated this interaction, and the local inventory contents are updated in the dynamic inventory tracking and dispensing system backend. More particularly, anything that the user takes from the cabinet is considered “checked out” by that user, and the system logs that the user has returned items placed into the cabinet.

In a preferred embodiment, a separate page navigable by the user shows a list of all inventory currently in the enclosure. In some embodiments, the page shows all inventory associated with the enclosure, or associated with a team to which the enclosure is assigned, including items not currently in the enclosure. If an item is not currently present, the user can select this item to be presented with said item's checkout information, to be specified by the administrator of the cabinet. This can include when the item was checked out of the cabinet, by whom, that user's contact information, etc. This information is queried from the dynamic inventory tracking and dispensing system backend.

Backend data management for each deployed cabinet, regardless of cabinet ownership, is handled by dynamic inventory tracking and dispensing system software and servers. As cabinet interactions are executed, local inventory changes are logged in dynamic inventory tracking and dispensing system's remote server for later viewing and processing by associated company users. This allows for viewing of company inventory not only at local cabinets, but also remotely via the dynamic inventory tracking and dispensing system web portal and mobile app, and through the backend API, Jira app, and Trello app. This also allows for companies to track inventory usage and associate generated analytics on a per-facility, per-installation, per team, or company wide basis. The dynamic inventory tracking and dispensing system backend logs any and all item attributes associated with each item as admin users dictate during item ingestion to the system.

In some embodiments, the backend DB/web portal allows for configurable interaction scripting on a per-item, per-interaction, per-cabinet, per-installation, or per-facility basis. i.e., once X item has been returned X number of times, alert X person. For instance, if X item of X type has been checked out for X period of time, the configured scripting alerts the current user via associated email to return item. This is simply exemplary of the functionality of configurable interaction scripting, and is not intended to be limited to this example.

When the enclosure suffers an internet outage and is unable to connect to the dynamic inventory tracking and dispensing system backend to update inventory interaction logs, the cabinet interface will store inventory interactions locally and upload offline interactions to the backend once an internet connection is re-established. Should a connection never be re-established, the cabinet can continue to be used, but interaction logs and inventory updates will remain inaccessible to any users.

The dynamic inventory tracking and dispensing system mobile app serves as a smartphone native method of accessing the dynamic inventory tracking and dispensing system inventory backend for inventory insights at a glance. The mobile app also allows for found inventory identification and access of associated information via NFC functionality. For example, in the event an employee of a customer company happens to find a loose piece of inventory that has been tagged with a dynamic inventory tracking and dispensing system RFID tag, they can use the NFC function of the dynamic inventory tracking and dispensing system mobile app to query the backend database for information on this particular piece of inventory, and can use that information to return the loose piece to its rightful place or user. NFC interactions are logged in the item event history as “taps,” which captures who tapped the item and when, and, in some embodiments, a GPS snapshot of where, making available a further degree of interaction history and traceability.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a diagram of a preferred embodiment of a dynamic inventory tracking and dispensing system;

FIG. 2 is a front perspective view of a cabinet of the dynamic inventory tracking and dispensing system;

FIG. 3 is a front perspective view of another embodiment of a cabinet of the dynamic inventory tracking and dispensing system;

FIG. 4 is a front view of the cabinet with its doors open and an illustration of the location of RFID antennas for tracking the contents and with several items present with individualized RFID tags;

FIG. 5 is a top perspective view of the cabinet showing the location of the electronics compartment;

FIG. 6 is a top-down view of the electronics compartment of the cabinet;

FIG. 7 is a diagram of steps involved in setting up and using a cabinet of a preferred embodiment of a dynamic inventory tracking and dispensing system;

FIG. 8 is a diagram of client onboarding of a preferred embodiment of a dynamic inventory tracking and dispensing system;

FIG. 9 is a diagram of initial inventory ingestion of a preferred embodiment of a dynamic inventory tracking and dispensing system;

FIG. 10 is a diagram of inventory check-out of a preferred embodiment of a dynamic inventory tracking and dispensing system; and

FIG. 11 is a diagram of inventory check-in of a preferred embodiment of a dynamic inventory tracking and dispensing system.

### DETAILED DESCRIPTION

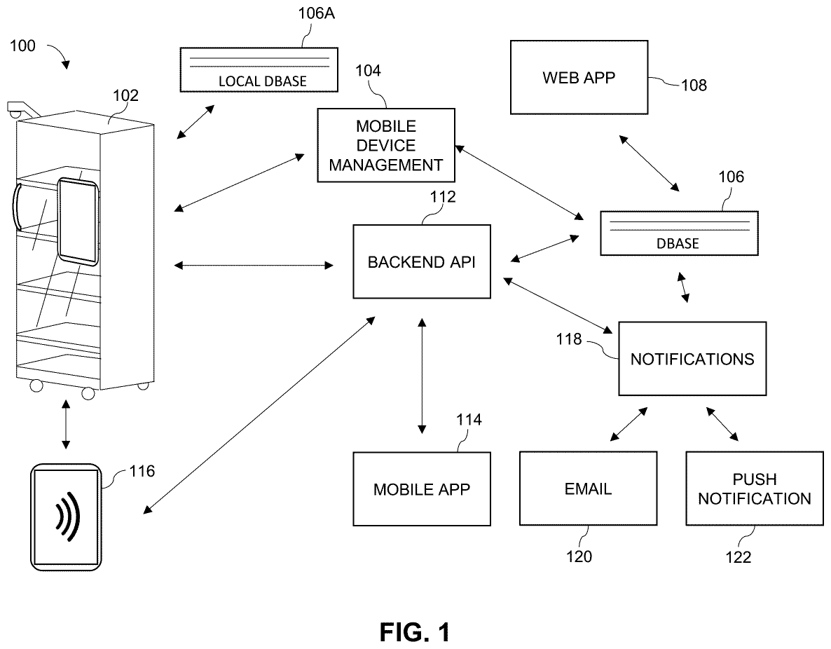

Referring initially to FIG. 1, a preferred embodiment of a dynamic inventory tracking and dispensing system is illustrated and generally designated 100. System 100 dispenses inventory through cabinet 102, which tracks its contents via radio frequency identification (RFID). In a preferred embodiment, cabinet 102 is managed by a cloud-based mobile device management system 104, such as that provided under the mark “Microsoft Intune.”

A database 106 tracks inventory and inventory usage. In a preferred embodiment, system 100 handles inventory tracking for multiple organizations, so database 106 tracks inventory on a per-organization basis. A new organization is added to system 100 through web app 108 or backend application programming interface (API) 112 using a create, read, update, and delete (CRUD) model. Afterward, an administrator for the organization adds the organization's inventory to database 106 using mobile app 114; the administrator can also perform this, and many other tasks discussed in connection with mobile app 114 via web app 108 in some preferred embodiments. Adding inventory to database 106 involves associating each item of inventory with an RFID tag attached to the item. Cabinet 102 then tracks the items with a built-in RFID scanner.

System 100 also includes a local database 106A which stores all information related to the cabinet 102 locally, including the items within the cabinet and their status as checked in or out. Importantly, this local database 106A maintains accurate information for cabinet 102 regardless of the communication link between cabinet 102 and main database 106 and is particularly useful during intermittent communications or power outages. In such circumstances, cabinet 102 maintains accurate information related to the items within the cabinet, and then once communication is restored, uploads the local database 106A, or at least untransmitted changes to the local database, to central database 106. This allows system 100 to function suitably for users despite intermittent communication, power outages, system updates, or other factors that interfere with the near real-time communication between cabinet 102 and database 106.

In order to check out items, a user authenticates with cabinet 102. In a preferred embodiment, this is done with a mobile pass involving near field communication (NFC) capabilities of the user's own mobile device 116. Additional or alternate authentication methods are present in some embodiments of cabinet 102, such as a fingerprint sensor embedded into the door of cabinet 102. Cabinet 102 is then unlocked, and the user retrieves the item or items desired. Cabinet 102 then re-scans its contents with its built-in RFID scanner, and items previously present that are no longer in cabinet 102 are considered to be checked out. Database 106 is updated accordingly. A similar process is used for returning items, in which the user authenticates with mobile device 116 to unlock cabinet 102, and places the item or items into cabinet 102. Cabinet 102 then re-scans its contents, and database 106 is updated to show the items as returned and present again.

An administrator for an organization, or any user that has access to the item, can “subscribe” to an item in order to watch its status and receive notifications 118 when the item is checked out and returned. Notifications 118 are provided as email notifications 120, or as push notifications 122 to a mobile device, or both; the types of notifications 120 desired are configurable by the subscriber in preferred embodiments.

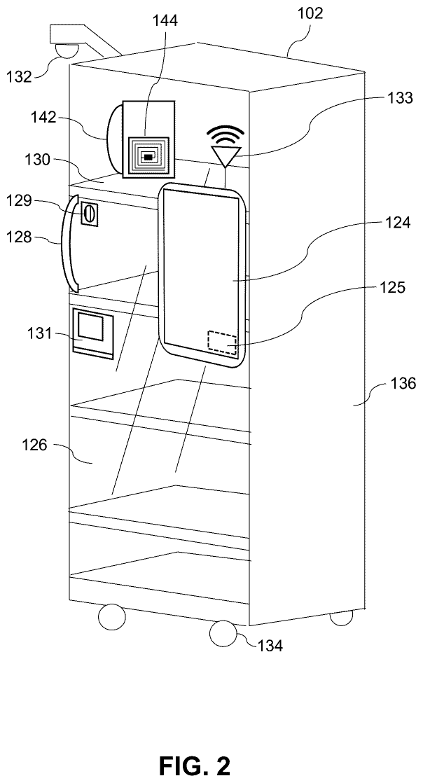

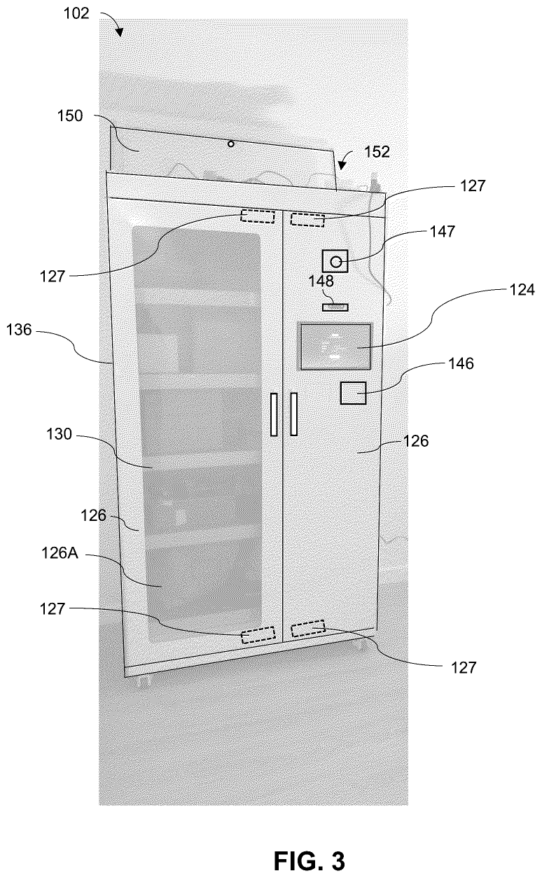

Referring now to FIG. 2, a perspective view of cabinet 102 is shown. In some embodiments, cabinet 102 has a touch screen device 124 embedded in door 126 of cabinet 102. In a preferred embodiment, touch screen device 124 is a fifteen-inch (15″) touch screen monitor. In the illustrated embodiment, touch screen device 124 is installed into door 126 in a portrait orientation; however, this orientation is not limiting, and landscape orientation is contemplated, as shown in the alternative embodiment of FIG. 3. Touch screen device 124 or a separate NFC reader in door 126 is used for authentication with the mobile pass on mobile device 116 (shown in FIG. 1), and touch screen device 124 also displays a scrollable list of the contents of cabinet 102. After authentication, door 126 is unlocked and can be opened with handle 128 to retrieve items from shelves 130, or to return previously checked-out items. Door 126 automatically locks again after it is closed, allowing the contents of cabinet 102 to be rescanned. An exemplary item 142 with an RFID tag 144 is shown on the top shelf 130.

Touch screen device 124 also includes an offline, or local database 125, allowing for users to retrieve or return items even when access to the Internet is unavailable. The offline database 125 is then synchronized with database 106 (shown in FIG. 1) when Internet access is restored.

Some embodiments of cabinet 102 include a security camera 132 for monitoring enclosure interactions by users and, in an alternate embodiment, providing an alternate method of user authentication via facial recognition. Four locking castor wheels 134 provide mobility for cabinet 102.

Walls 136 are made of a radio frequency (RF) rejecting material in order to prevent the internal RFID scanner of cabinet 102 from picking up RFID tags outside the enclosure. Door 126 is transparent in a preferred embodiment, and also made of an RF rejecting material.

As indicated above, alternate embodiments of cabinet 102 have different authentication systems, which are either the sole authentication method or available as alternate authentication methods, depending on the embodiment. These include fingerprint reader 129, facial recognition via camera 147 (shown in FIG. 3), keycard reader 131, or other authentication systems known in the art.

In the case of fingerprint or facial recognition, the cabinet interface includes corresponding onboarding user flow where user credentials corresponding to face/print are stored with dynamic inventory tracking and dispensing system servers.

In the case of keycard, the dynamic inventory tracking and dispensing system backend includes API integration capabilities to facilitate communication with customer company employee directory. Given the security implications, this integration is required to be configured by an administrator of the customer company. The dynamic inventory tracking and dispensing system backend is only served whatever the admin configured to be associated with keycard authentication requests from internal company DB, e.g., name, title, company email, phone number.

Cabinet 102 is connected to WiFi via link 133, authenticated with Dynamic Inventory Tracking and Dispensing System servers, and associated in backend with customer company DB.

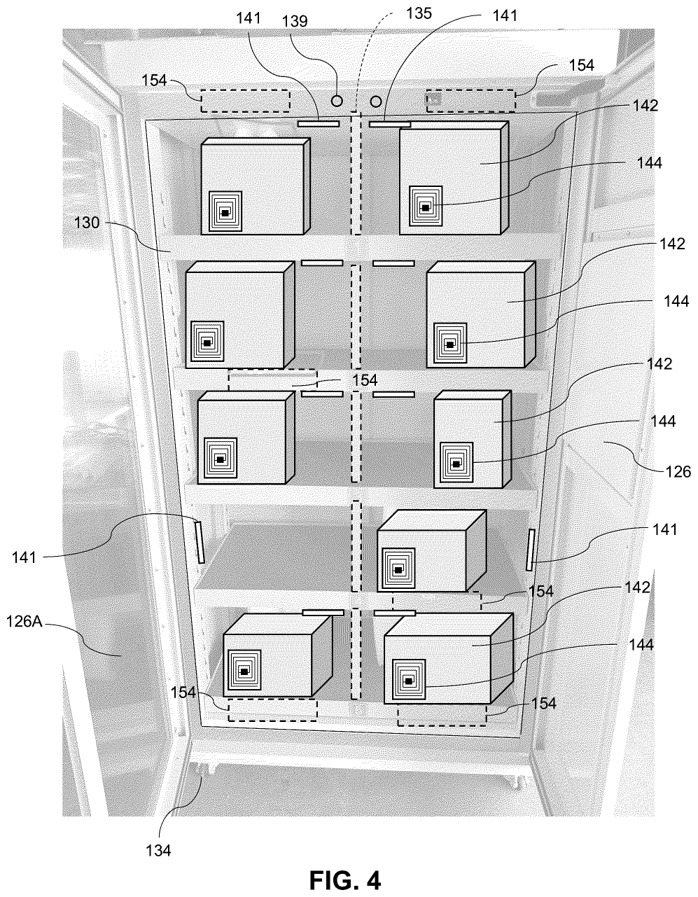

Referring now to FIG. 3, another preferred embodiment of cabinet 102 is illustrated. This embodiment of cabinet 102 has two doors 126, with a visually transparent window 126A in the left door 126 and touchscreen device 124 embedded in the right door 126 in a landscape orientation. Doors 126 are secured with electronically controlled lock 127 (shown in dashed lines), and can be opened after authentication via NFC reader 146 or entering an access code into touchscreen device 124. In one embodiment, there is only one electronic lock 127 present which secures the right door, with the left door held closed by the right door, and requires the left door to be closed first. Cabinet 102 may be equipped with a plunger switch 139 which senses whether the left side door 126 is left open after the right-side door 126 is closed. If that occurs a buzzer will sound to alert those nearby, and a “door left open” alert is sent to the proper administrators. Alternatively, both doors may be controlled by locks 127 such that depending on what items a user is seeking or returning, one or both of the doors may be unlocked, which is particularly useful in cabinets 102 having a central divider 135 (shown in dashed lines in FIG. 4). Also, with multiple locks 127, the cabinet can easily determine whether a door was left open, and a buzzer may alert those nearby, or an alert may be sent to the proper administrators.

In preferred embodiments, NFC reader 146 also supports commonly used security badge RFID frequencies; in some embodiments, badges are matched to user profiles, allowing them to be used in place of a mobile pass for authentication and access to cabinet 102. Light-emitting diode (LED) lights 148 indicate whether cabinet 102 is locked or unlocked. As with other embodiments, the walls 136, doors 126 and window 126A of cabinet 102 are made with RF-rejecting materials.

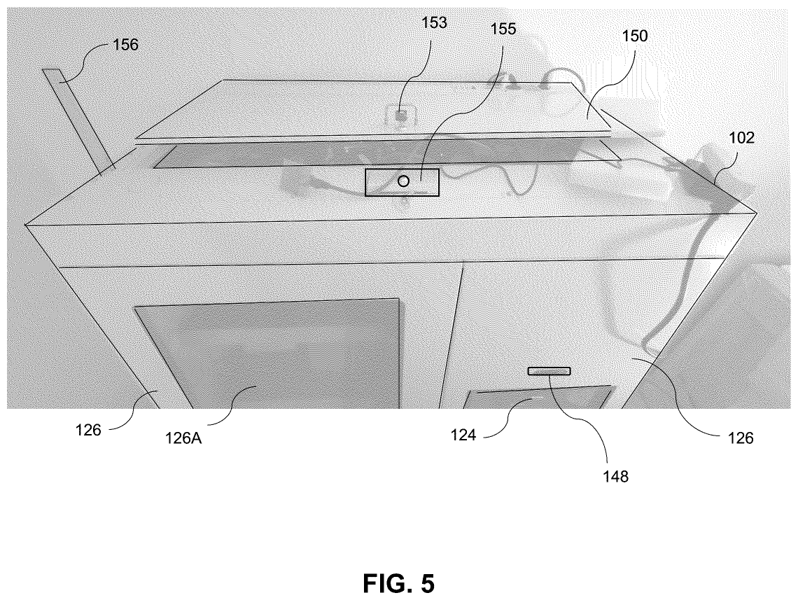

Access door 150 to electronics compartment 152 is illustrated in an open configuration. Access door 150 is typically closed during normal use, and in preferred embodiments requires a physical key to unlock using lock 153 (shown in FIG. 5).

Referring now to FIG. 4, cabinet 102 is illustrated with doors 126 open to show an unobstructed view of shelves 130. RFID reader antennas 154 are located throughout cabinet 102 in order to identify multiple items 142 present in cabinet 102. A preferred embodiment of an antenna 154 layout is illustrated, with two antennas 154 located in a top compartment above the first shelf 130 (counting down from the top), another antenna 154 located inside the second shelf 130 on the left side, an antenna 154 located inside the fourth shelf 130 on the right side, and two antennas 154 located in the bottom shelf 130. The pairs of antennas 154 in the top compartment and bottom shelf 130 each include an antenna 154 on the left side and an antenna 154 on the right side. This layout provides thorough coverage sufficient to read RFID tags 144 and track items 142 within cabinet 102. It is to be appreciated that antennas 154 are capable of reading RFID tags 144 on items 142 anywhere within the cabinet 102, and the number of antenna 154 or location on each shelf is merely exemplary of a preferred embodiment; other configurations are fully contemplated herein. Similarly, placement of items 142 as shown in FIG. 4 with the RFID tags 144 facing doors 126 is not required. Also, shelves 130 are adjustable and can be moved up, down, or removed entirely to accommodate different sized items 142 and other space needs.

Positioned strategically within cabinet 102, interior illumination LEDs 141 activate when the cabinet 102 is unlocked and deactivate when doors 126 are closed. LEDs 141, typically mounted under shelves 130 or on walls 136, provide internal illumination to cabinet 102 to assist a user in locating and retrieving or returning a specific item 142 to cabinet 102. It is to be appreciated that the position and number of LEDs 141 can vary depending on the specific dimensions of cabinet 102, the number and location of shelves 130, and the ambient light availability.

Referring now to FIG. 5, a top perspective view of cabinet 102 is illustrated. Access door 150 is shown in a partially open configuration. WiFi antenna 156 is located on the top of cabinet 102 to facilitate internet access. As mentioned above, internet access can be set up through WiFi or ethernet as needed or preferable in a particular installation.

Access door 155 is located just in front of access door 150 that is also locked by a physical key. Access door 155, when opened, provides a fail-safe method for unlocking cabinet 102. Specifically, in a preferred embodiment, access door 155 gives access to a steel drawstring that when pulled, will mechanically unlock the cabinet doors 126. This acts as a mechanical lock release fallback to provide access to cabinet 102 in case of power failure, or in the event the electronic lock malfunctions.

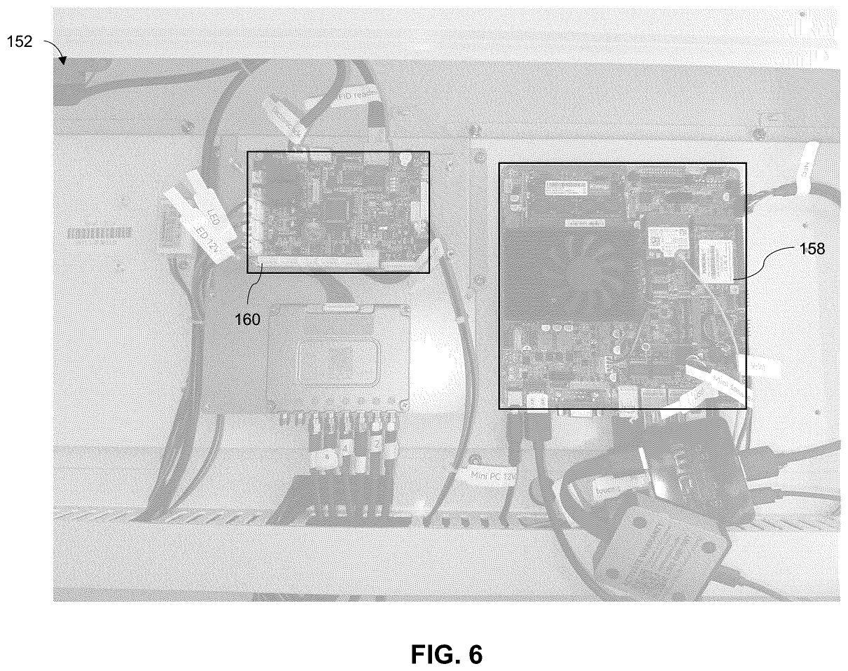

Referring now to FIG. 6, a top-down view of an exemplary electronics compartment 152 is shown. A preferred embodiment of cabinet 102 (see FIGS. 2 and 3) is controlled by a computing device, such as computer 158 running Windows 10 Enterprise IoT with the cabinet app in kiosk mode. In an alternate embodiment, touchscreen device 124 (see FIGS. 2 and 3) is a tablet, providing its own computing hardware. It will be apparent to a person of ordinary skill in the art that a variety of computing devices can be incorporated in the present invention so long as it is configurable to achieve the functionality described here. Similarly, other operating systems can be used in place of Windows 10 Enterprise IoT, such as other versions of Windows, Linux, BSD operating systems, other operating systems known in the art, or a custom-designed operating system.

Additional electronics, such as board 160, are present in some preferred embodiments to control the electronic lock of cabinet 102, LED lights 148, RFID readers, and/or other cabinet 102 hardware that is not directly managed by computer 158. From reference to FIGS. 1, 2, and 3, the components of dynamic inventory tracking and dispensing system 100 can be seen as presented in a preferred embodiment. It is to be appreciated, however, that the particular cabinet 102 design including the electronics compartment 152 therein, are merely exemplary of a preferred embodiment, and the particular shape, size, arrangement and materials are not limited to the embodiment. Rather, it will be apparent to one skilled in the art that the RFID containing cabinet 102 can incorporate a variety of shapes and materials, as well as the placement and shape of the electronics compartment 152, can be in other suitable locations in or on cabinet 102 without departing from the present invention. Similarly, the identification of particular computer components 158 and 160 are merely exemplary of a preferred embodiment, and other computer and electronics components, so long as they accomplish the functionality described herein, are fully incorporated into the present invention.

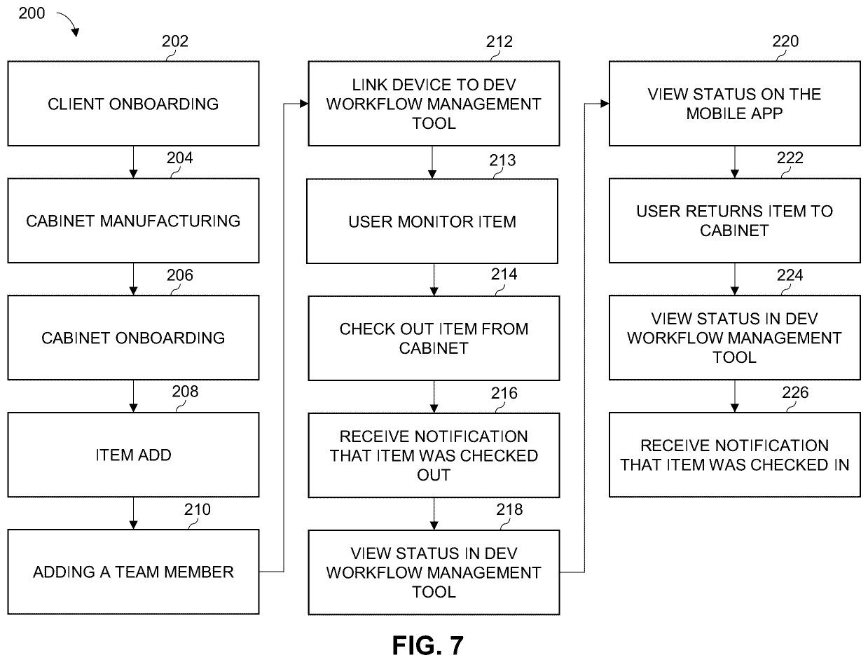

Referring now to FIG. 7, a diagram of setting up and using a cabinet in a dynamic inventory tracking and dispensing system 100 is illustrated and generally designated 200.

A preferred embodiment of a dynamic inventory tracking and dispensing system 100 (see FIG. 1) serves multiple organizations with teams that have one or multiple cabinets 102 (see FIG. 2) each. As a result, the initial step 202 involves client onboarding, which includes adding a new organization to the system. One or more teams are also created and associated with the organization. An administrator from the organization is designated and receives an invite allowing access to manage items and team members for their organization through mobile app 114 or web app 108 (see FIG. 1). A mobile pass (e.g., an Apple or Android Wallet pass) is generated for the administrator, and one or more cabinets are assigned to the organization and teams.

Step 204 is cabinet manufacturing. A mobile device management service, such as Microsoft Intune, is used to manage the software on touch screen device 124 of cabinet 102 (see FIG. 2). Cabinet 102 is initialized with the software by a technician in the manufacturing facility or another pre-delivery location. The cabinet is turned off after being brought up, and turned back on again to emulate the deployment process.

Step 206 is cabinet onboarding, and is typically performed together with step 208 of adding items to system 100 (shown in FIG. 1). After logging into mobile app 114 (see FIG. 1) via the invite, the organization's administrator completes the cabinet onboarding flow, checking in the device. The administrator authenticates with cabinet 102 (see FIG. 2) using the mobile pass in order to unlock cabinet 102 and place items added to system 100 (shown in FIG. 1) through step 208 into cabinet 102.

Step 208 involves adding a tag to the item, and using mobile app 114 (shown in FIG. 1) to enter the item information into the platform and associate it to the tag using the NFC reader on the administrator's mobile device. Preferred embodiments of the tags are attached to inventory items for identification, such as via an adhesive backing, heat-shrink protective sleeve, or secure loop tag, and are dual frequency tags that are compatible with a UHF RFID scanner in cabinet 102 as well as an NFC reader on modern smartphones. In a preferred embodiment, various RFID tags may be used depending on the item being tagged. For instance, when considering the RF characteristics of particular RFID tags available on the market, the user may affix one tag type for anything but metal objects, one tag type specifically for metal objects, and one tag type specifically for tools. Other configurations are fully contemplated herein with the overarching requirement that each item within cabinet 102 is identified with a unique RFID tag 144.

Step 210 is adding team members, and is performed by the organization's administrator. The administrator sets the team member's role and sends an invite allowing the team member to log into mobile app 114 (shown in FIG. 1) in order to check out items from cabinets 102 (shown in FIG. 2) assigned to the team member's team. The team member is served a mobile pass, such as an Android or iOS wallet pass, for authentication with cabinets 102 using the team member's mobile device 116 (shown in FIG. 1).

Step 212 is linking a device to the workflow management tool, allowing the user to “watch” a device, that is, receive notifications when it is checked in or out. In a preferred embodiment, workflow management software, such as Jira or Trello, is used to support this feature. A User creates a ticket and links an item to it. The item (unless checked out) shows as checked in.

The user can subscribe to watch, or monitor, the item in step 213, which results in the user receiving a push notification or an email when the item is checked in or out. In some embodiments, creating a ticket to watch an item is limited to the organization's administrator or other users authorized to do so.

Step 214 is checking out an item from cabinet 102 (shown in FIG. 2). The user unlocks cabinet 102 using the mobile pass on the user's mobile device 116 (shown in FIG. 1). The user checks out the item by retrieving it from cabinet 102; cabinet 102 is then closed and then re-scans the items inside and automatically updates the status of the item as being checked out by the user. Removal of the device is reflected in API 112 (shown in FIG. 1). If the item has been watched via step 213, then step 216 is performed, causing the person watching the item to receive an email, push notification, or both, that the device has been checked out. An organization's administrator or other authorized user can also view the status of the device through API 112 (e.g., via mobile app 114) and see that it was checked out, as illustrated by step 218; this step is supported with third-party workflow management software in some embodiments, as discussed above in conjunction with step 212.

Step 220 is viewing the status of the item on mobile app 114 (shown in FIG. 1). This is performed by tapping the NFC tag with mobile device 116 (shown in FIG. 1), which causes the current status of the item to be displayed, and is also when the system captures the user's geo-location and associates the location with the item, which allows users to infer an item's location. In some embodiments, this allows for transfer of “ownership” of the item outside of cabinet 102 (shown in FIG. 1), that is, an item initially checked out by one user can be transferred to a second user, and is then considered as checked out by the second user by system 100 (shown in FIG. 1).

In step 222, a user returns a checked-out item to cabinet 102 (shown in FIG. 2). Like in step 214, the user unlocks cabinet 102 using the mobile pass on the user's mobile device 116 (shown in FIG. 1). The user then returns the item by placing it in cabinet 102, and once doors 126 are closed, cabinet 102 then rescans the items inside and automatically updates the status of the item as being checked-in and now present in cabinet 102. Step 224 functions in the same manner as step 218, allowing an organization's administrator or other authorized user to view the status of the item and see that it was checked in. Likewise, step 226 functions in the same manner as step 216: A user watching the item receives an email, push notification, or both, that the device has been checked in.

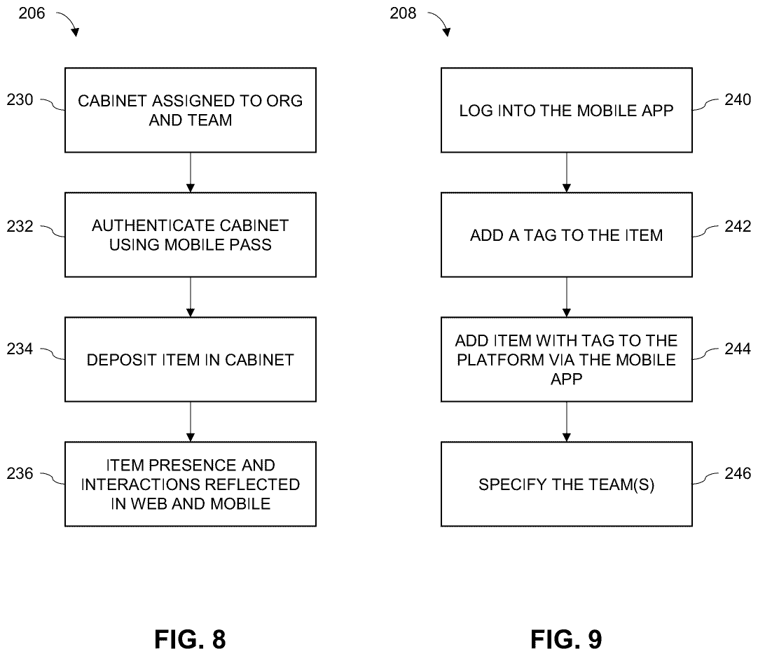

Referring now to FIG. 8, step 206 of flow 200 (shown in FIG. 7) is illustrated in greater detail. After a cabinet 102 (see FIG. 2) is assigned to an organization and a team within the organization, as illustrated by step 230, an administrator for the organization completes the onboarding flow for cabinet 102. In step 232, the administrator authenticates using a mobile device 116 (see FIG. 1), and more particularly, the mobile pass generated for the administrator, in order to unlock cabinet 102. Then an item, previously tagged and added to platform 100 (see FIG. 1) in step 208 (see FIG. 9), is placed into cabinet 102 in step 234. Multiple items may be placed into cabinet 102 in step 234, if desired. As a result of step 234, cabinet 102 scans its contents when closed, and the presence of the item or items placed into it are reflected in web app 108 (see FIG. 1) and mobile app 114 (see FIG. 1) in step 236.

Referring now to FIG. 9, step 208 of flow 200 (shown in FIG. 7) is illustrated in greater detail. In step 240, an organization's administrator logs into mobile app 114 (shown in FIG. 1). If it is the first login by the administrator, an invite code from step 202 (see FIG. 7) is used to allow the administrator to log in. In step 242, the administrator tags an item that is to be placed into cabinet 102 (shown in FIG. 2). Preferred embodiments of tags are dual-frequency and have an adhesive backing to facilitate application onto an item. The administrator also adds the item to platform 100 (see FIG. 1) in step 244 via mobile app 114 by scanning the tag or tapping via NFC, and providing a description of the item. In a preferred embodiment, associating the item with a team or teams is performed in mobile app 114 as part of adding the item to platform 100, as illustrated by step 246.

In some embodiments, for faster ingestion of multiple new items of the same type, the administrator can configure an item profile preset with default item attributes that can be applied automatically to new inventory via web app 108 (shown in FIG. 1), mobile app 114 (also shown in FIG. 1), or cabinet interface on touchscreen device 124 (shown in FIG. 2).

Likewise, in some embodiments, new distinct items (i.e., not of the same type) can be added by the interface on touchscreen device 124 after being placed into cabinet 102 and their RFID tags being read. This is performed for one item at a time in most embodiments, resulting in the process being slower than other methods of new item ingestion. In this case, the items remain in the cabinet when ingestion is complete, until being checked out by a team member.

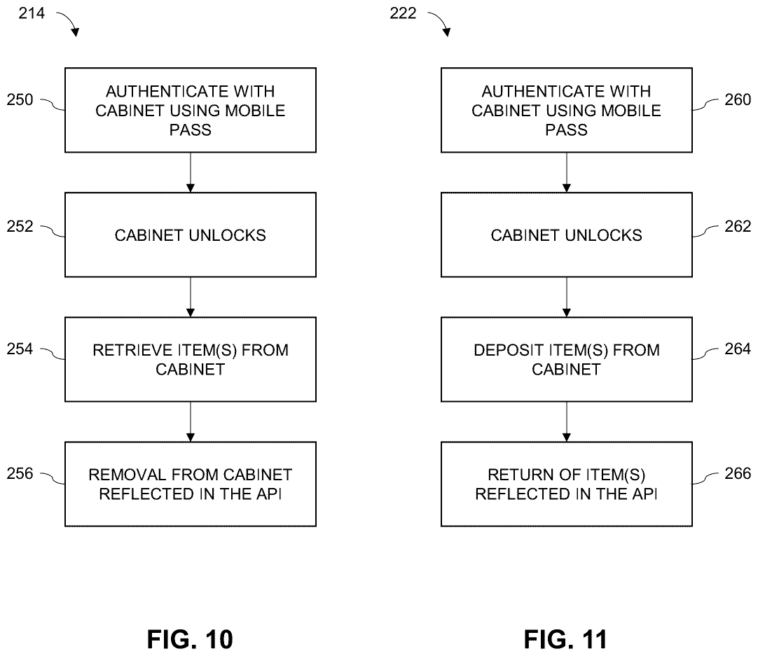

Referring now to FIG. 10, step 214 of flow 200 (shown in FIG. 7) is illustrated in greater detail. In order to check out an item from cabinet 102 (shown in FIG. 2), a team member authenticates with cabinet 102 using the mobile pass on mobile device 116 (shown in FIG. 1), as illustrated by step 250. Authentication results in cabinet 102 unlocking, as illustrated by step 252. The team member then retrieves the desired item or items from cabinet 102, as illustrated by step 254. When cabinet 102 is closed, it rescans its contents, and removal of the item or items is reflected in mobile app 114 (shown in FIG. 1) and web app 108 (shown in FIG. 1) and associates the check-out of those items with the team member who authenticated to unlock cabinet 102, as illustrated by step 256.

User profile and interaction information is associated with the requisitioned inventory in database 106 (shown in FIG. 1) as, e.g., X user (such as the user's title, email, phone number, geolocation) took X object at X time from X cabinet located at X facility. In the case of a severed connection to database 106, this data is stored locally in local database 125 until such time connection is re-established. In a preferred embodiment, system 100 does not make local information available via cabinet 102 interface.

Referring now to FIG. 11, step 222 of flow 200 (shown in FIG. 7) is illustrated in greater detail. As illustrated by the detail of step 222, returning, or checking in, an item functions similarly to checking out an item as illustrated in step 214 (see FIG. 10). In order to return an item to cabinet 102 (shown in FIG. 2), a team member authenticates with cabinet 102 using the mobile pass on mobile device 116 (shown in FIG. 1), as illustrated by step 260. Authentication results in cabinet 102 unlocking, as illustrated by step 262. The team member then places the previously checked-out item or items into cabinet 102, as illustrated by step 264. When cabinet 102 is closed, it rescans its contents, and check-in of the item or items is reflected in mobile app 114 (shown in FIG. 1) and web app 108 (shown in FIG. 1), as illustrated by step 266. Available inventory is updated in database 106 (shown in FIG. 1), and item check-out history is retained in database 106.

While there have been shown what are presently considered to be preferred embodiments of the present invention, it will be apparent to those skilled in the art that various changes and modifications can be made herein without departing from the scope and spirit of the present invention.

What is claimed is:

1. A dynamic inventory tracking and dispensing system, comprising:
a cabinet comprising:
a body formed with radio-frequency-rejecting walls,
a door having a locked configuration and an unlocked configuration,
a near field communication (NFC) reader,
an internal radio frequency identification (RFID) scanner, and
a computing device in communication with said NFC reader and said RFID scanner and having a local database;
a mobile pass readable by the NFC reader of the cabinet;
one or more items, each item having an RFID tag; and
a server having a database in communication with the local database and configured for tracking a status of each of the one or more items,
wherein the computing device within the cabinet is configured to read the mobile pass with the NFC reader, unlock the door in response to reading the mobile pass, wait for the door to be closed, lock the door, scan contents of the cabinet with the internal RFID scanner to identify items of the one or more items that have been removed from the cabinet or returned into the cabinet, update the local database, and notify the server of items that have been removed or returned,
wherein the server updates the status of the items that have been removed to a checked-out status and associates them with the mobile pass, and
wherein the server updates the status of the items that have been returned to a checked-in status.

2. The dynamic inventory tracking and dispensing system of claim 1, wherein the cabinet further comprises an offline database configured to track the status of each of the one or more items when communication with the server is interrupted.

3. The dynamic inventory tracking and dispensing system of claim 1, further comprising a mobile app in communication with the server and capable of displaying the status of the one or more items.

4. The dynamic inventory tracking and dispensing system of claim 1, further comprising a web app in communication with the server and capable of displaying the status of the one or more items.

5. The dynamic inventory tracking and dispensing system of claim 1, wherein the cabinet further comprises a touchscreen display integrated into the door and configured to display a scrollable list of items of the one or more items that are present in the cabinet.

6. The dynamic inventory tracking and dispensing system of claim 1, wherein the server is configured to send notifications to a subscriber when an item of the one or more items is checked out or checked in.

7. A dynamic inventory tracking and dispensing system, comprising:
a plurality of items, each item having a radio frequency identification (RFID) tag;
one or more cabinets containing items from the plurality of items and configured to identify the items by scanning the RFID tags;
one or more mobile passes; and
a database with an associated backend application programming interface (API), in which each item of the plurality of items is associated with a cabinet of the one or more cabinets in which the item is stored;
wherein each item is associated with a status in the database indicating that the item is checked in when it is in the cabinet associated with the item, and that the item is checked out when it is not in the cabinet associated with the item,
wherein each mobile pass of the one or more mobile passes is operable to unlock a cabinet of the one or more cabinets to retrieve or return items of the plurality of items, and
wherein each cabinet is configured to communicate its contents to the database when items are retrieved or returned, causing the database to update the status of associated with the items that were retrieved or returned.

8. The dynamic inventory tracking and dispensing system of claim 7, wherein the RFID tags associated with the items of the plurality of items are dual-frequency tags readable by a near field communication (NFC) reader on a mobile device.

9. The dynamic inventory tracking and dispensing system of claim 8, further comprising a mobile application operable to add new items to the database using the backend API by scanning an RFID tag on each new item.

10. The dynamic inventory tracking and dispensing system of claim 9, wherein the mobile application is operable to display the status associated with an item of the plurality of items.

11. The dynamic inventory tracking and dispensing system of claim 7, further comprising a web app in communication with the database and operable to display the status of items of the plurality of items.

12. The dynamic inventory tracking and dispensing system of claim 7, wherein each cabinet of the one or more cabinets further comprises an integrated touchscreen display configured to display a scrollable list of items of the plurality of items that are present in the cabinet.

13. The dynamic inventory tracking and dispensing system of claim 12, wherein the scrollable list of items is hidden until the cabinet is unlocked with a mobile pass of the one or more mobile passes.

14. The dynamic inventory tracking and dispensing system of claim 7, wherein each cabinet of the one or more cabinets further comprises a transparent door.

15. The dynamic inventory tracking and dispensing system of claim 14, wherein the door is made from a radio-frequency rejecting material.
